(19) United States
(12) Patent Application Publication
(10) Pub. No.: US 2015/0139072 A1
(43) Pub. Date: May 21, 2015

(54) SATELLITE MESH COMMUNICATION SYSTEM AND ACM CONTROL METHOD USING THE SAME

(71) Applicant: Electronics and Telecommunications Research Institute, Daejeon (KR)

(72) Inventors: Hyun Ha HONG, Daejeon (KR); Deock Gil OH, Daejeon (KR)

(21) Appl. No.: 14/299,189

(22) Filed: Jun. 9, 2014

(30) Foreign Application Priority Data
Nov. 19, 2013 (KR) 10-2013-0147177

(51) Int. Cl. H04W 72/04; H04W 72/08

(52) U.S. Cl. CPC H04W 72/0446; H04W 72/085; H04W 84/06
USPC 370/326

(57) ABSTRACT

Provided are a satellite mesh communication system and an adaptive coding modulation (ACM) control method using the same. The ACM control method include establishing, by the central station, star and mesh connections between the terminal stations, receiving, by each terminal station, a data burst including MODCOD information for ACM control through the established mesh connection, checking, by each terminal station, a mesh connection link state in response to reception of the data burst, determining, by each terminal station, new requested MODCOD information in units of established mesh connections to transmit a data burst including the determined requested MODCOD information to a partner terminal station, and changing a previous MODCOD according to the requested MODCOD to transmit a data burst in units of mesh connections according to the changed MODCOD.

### CROSS-REFERENCE TO RELATED APPLICATIONS

This application claims priority under 35 U.S.C. §119 to Korean Patent Application No. 10-2013-0147177, filed on Nov. 19, 2013, the disclosure of which is incorporated herein by reference in its entirety.

### TECHNICAL FIELD

The present invention relates to a satellite mesh communication system and an adaptive coding modulation (ACM) control method using the same, and more particularly, to a satellite mesh communication system and an ACM control method using the same, which allows a terminal station to measure a packet loss ratio (or signal-to-noise ratio) for each of a plurality of mesh connections and notify the measured packet loss ratio (or signal-to-noise ratio) to a corresponding terminal station using a data burst on a corresponding mesh connection to perform fast distributed processing on ACM control of the plurality of mesh connections.

### BACKGROUND

Digital Video Broadcasting-Second Generation (DVB-S2) is a satellite broadcast communication standard in Europe, which uses an adaptive coding modulation (ACM) technique to enhance transmission efficiency by 30% or more, compared to DVB-S. The ACM technique may select an encoding and modulation scheme optimally suitable for a channel state according to a degree of signal attenuation on a satellite link to provide high bandwidth efficiency and throughput, in order to cope with satellite channel characteristics, that is, variation in link quality.

According to the ACM technique, a terminal measures a channel state and autonomously selects an appropriate encoding and modulation scheme on the basis of a result of the measurement. Alternatively, a terminal transmits a current signal-to-noise ratio (SNR) to a central station through a return direction link such that the central station may select an appropriate encoding and modulation scheme. Subsequently, the central station changes the encoding and modulation scheme according to the request of the terminal, using the received information, or predicts and determines a most appropriate encoding and modulation scheme on the basis of the SNR value transmitted by the terminal to encode and modulate data in a forward link according to the determined encoding and modulation scheme and then transmit the encoded and modulated data.

The ACM control technique will be described in more detail with reference to FIG. 1.

FIG. 1 is a view illustrating a network connection structure of a general star/mesh satellite communication system.

As shown in FIG. 1, the star/mesh satellite communication system includes a satellite 20, a central station 10, and a plurality of terminal stations 30 and 31.

A satellite communication service using the system is achieved through a satellite star connection between the terminal stations 30 and 31 and the central station 10 or a satellite mesh connection between the terminal station 30 and the terminal station 31.

For the star communication, a time division multiple (TDM) forward link based on a Digital Video Broadcasting Second Generation (DVB-S2) is used from the central station 10 to the terminal stations 30 and 31, and a Multi Frequency-Time Division Multiple Access (MF-TDMA) return link transmission based on Digital Video Broadcasting-Return Channel by Satellite (DVB-RCS) is used from the terminal stations 30 and 31 to the central station 10.

In addition, for a transparent satellite communication system, the terminals 30 and 31 should be able to receive a DVB-RCS based MF-TDMA signal in addition to a TDM forward link in order to perform mesh communication.

The satellite communication system measures/predicts a signal-to-noise ratio (SNR) or packet loss ratio and applies various technologies such as power and ACM control of star and mesh connection links in order to secure a certain level of communication quality even when a link state is changed due to rain-attenuation, etc.

The related art channel adaptive technology for the star connection includes power or ACM control technology using a signal-to-noise ratio (or packet loss ratio) on forward and return links, and the related art technology for the mesh connection includes power or ACM control technology using a signal-to-noise ratio.

In a channel adaptive technology for the mesh connection, the terminal stations 30 and 31 measure a signal-to-noise ratio when a change in link state is detected, notifies the measured signal-to-noise ratio to the central station 10 via the satellite 20 using a return link signaling message on the start connection, and then perform power or ACM control on the mesh connection under the control through a forward link signaling message.

Accordingly, there are limitations in that it takes much time due to satellite delay when the ACM control is performed on the mesh connection, and a load concentrates on the central station 10 when a signal is processed. Thus, additional research and development is needed to overcome the limitations.

### SUMMARY

Accordingly, the present invention provides a satellite mesh communication system and an adaptive coding modulation (ACM) control method using the same, in which a terminal station can measure a packet loss ratio (or signal-to-noise ratio) for each of a plurality of mesh connections and notify the measured packet loss ratio (or signal-to-noise ratio) to a corresponding terminal station using a data burst on a corresponding mesh connection, thereby performing fast distributed processing on ACM control of the plurality of mesh connections.

In one general aspect, a satellite mesh communication system includes: a central station configured to signal each terminal station through a star communication link, allocate a time slot for data burst transmission to each terminal station through the signaling, determine a MODCOD for mesh communication between terminals, and transmit the MODCOD according to the allocated time slot to each terminal station; and a plurality of terminal stations configured to transmit/receive a data burst through a mesh connection with a corresponding terminal station through the MODCOD determined by the central station, check a state of a link connected to the partner terminal station, and transmit/receive a data burst to/from the corresponding terminal station according to the new determined MODCOD.

The data burst transmitted/received between the terminal stations may include a burst header field and a burst payload field, and the burst header field may include a mesh identifier field for identifying the terminal station intended to perform the mesh communication and a MODCOD information field for performing mesh connection ACM control determined depending on a link state.

The checking of a state of a link connected with the corresponding terminal station may include calculating a packet loss ratio of a received packet to check the link state.

The checking of a state of a link connected with the corresponding terminal station may include calculating a signal-to-noise ratio of a received packet to check the link state.

Each of the plurality of terminal stations may check a mesh connection identifier recorded in the data header of the received data burst, compares the recorded mesh connection identifier with a mesh connection identifier of the terminal station, receives a data burst when the mesh connection identifiers are the same, and deletes the received data burst when the mesh connection identifiers are not the same.

In another general aspect, an ACM control method in a satellite mesh communication system including a central station and a plurality of terminal stations. The ACM control method includes: establishing, by the central station, star and mesh connections between the terminal stations; receiving, by each terminal station, a data burst including MODCOD information for ACM control through the established mesh connection; checking, by each terminal station, a mesh connection link state in response to reception of the data burst; determining, by each terminal station, new requested MODCOD information in units of established mesh connections to transmit a data burst including the determined requested MODCOD information to a partner terminal station; and changing a previous MODCOD according to the requested MODCOD to transmit a data burst in units of mesh connections according to the changed MODCOD.

The data burst transmitted/received between the terminal stations may include a burst header field and a burst payload field, and the burst header field may include a mesh identifier field for identifying the terminal station intended to perform the mesh communication and a MODCOD information field for performing mesh connection ACM control determined depending on a link state.

The checking of a mesh connection link state may include calculating a packet loss ratio of the received packet or a signal-to-noise ratio of the received packet to check a link state.

Each of the plurality of terminal stations may check a mesh connection identifier recorded in the data header of the received data burst, compares the recorded mesh connection identifier with a mesh connection identifier of the terminal station, receives a data burst when the mesh connection identifiers are the same, and deletes the received data burst when the mesh connection identifiers are not the same.

Other features and aspects will be apparent from the following detailed description, the drawings, and the claims.

### BRIEF DESCRIPTION OF THE DRAWINGS

FIG. 1 is a view illustrating a network connection structure of a general star/mesh satellite communication system.

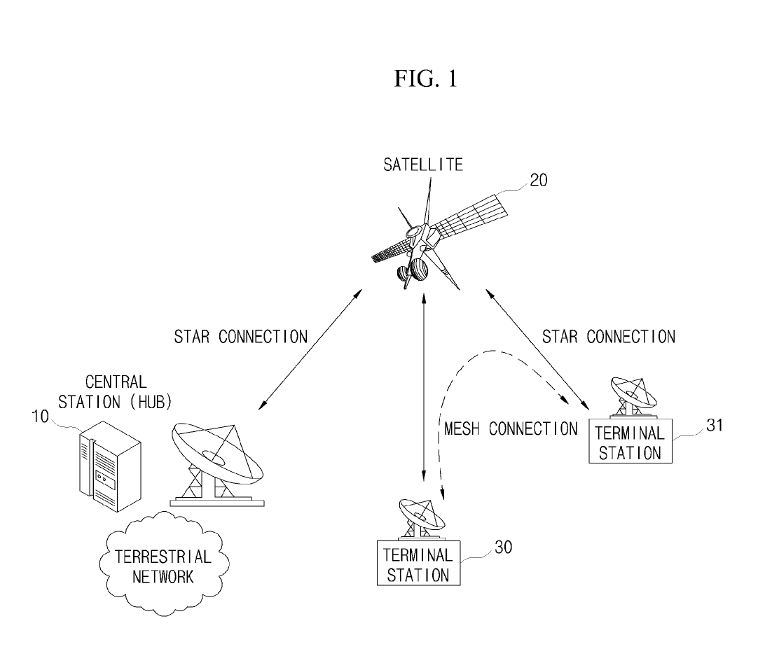

FIG. 2 is a view illustrating a network connection configuration of a satellite communication system according to the present invention.

FIG. 3 is a view illustrating an example of a data burst structure for ACM based mesh connection according to the present invention.

FIG. 4 is a view illustrating an example of an ACM control procedure in the satellite communication system according to the present invention.

FIG. 5 is a view illustrating another example of an ACM control procedure in the satellite communication system according to the present invention.

FIG. 6 is a flowchart illustrating an ACM control method in the satellite communication system according to the present invention.

### DETAILED DESCRIPTION OF EMBODIMENTS

Hereinafter, embodiments of the present invention will be described in detail with reference to the accompanying drawings.

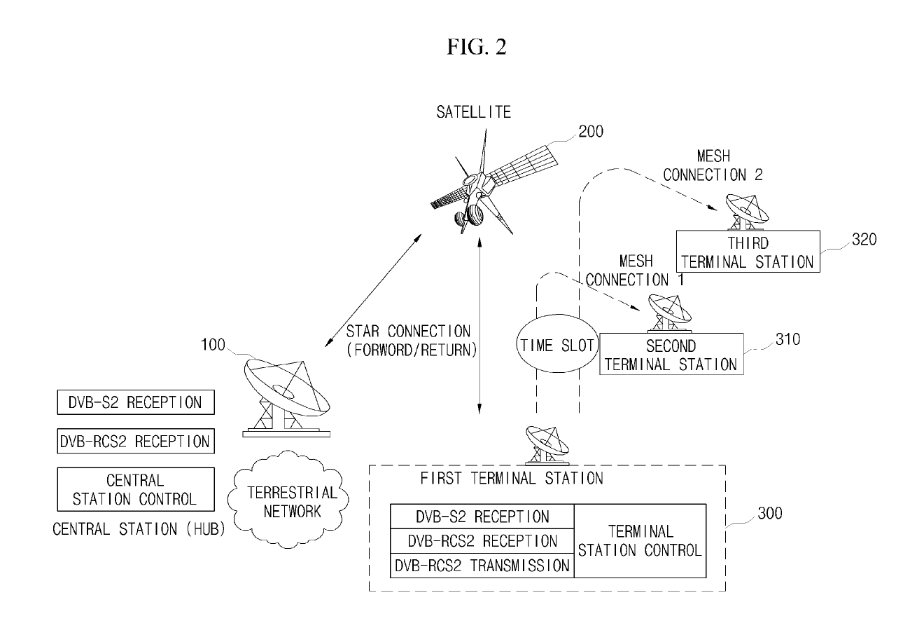

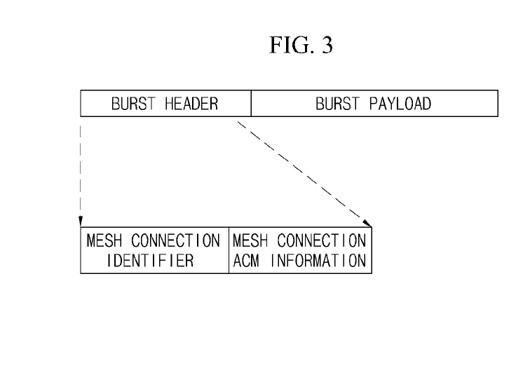

FIG. 2 is a view illustrating a network connection configuration of a satellite communication system according to the present invention, and FIG. 3 is a view illustrating an example of a data burst structure for ACM based mesh connection according to the present invention.

Referring to FIG. 2, in the satellite communication system according to the present invention, a plurality of terminal stations 300, 310, and 320 are connected with each other via a central station 100 and a satellite 200 through star connection of forward and return links, and two unidirectional mesh connections are established from the first terminal station 300 to the second and third terminal stations 310 and 320.

The central station 100 includes a DVB-S2 transmission function for transmitting forward link, a DVB-RCS2 based MF-TDMA reception function for receiving a return link, and a central station control function for performing control of signaling and link connection.

The first to third terminal stations 300, 310, and 320 each include a DVB-S2 based reception function for receiving a forward link, a DVB-RCS2 based MF-TDMA transmission function for transmitting a return link, and a DVB-RCS3 reception function for mesh communication between the terminal stations 300, 310, and 320. In addition, the first to third terminal stations 300, 310, and 320 each includes a terminal station control function of controlling the reception and transmission functions and performing signaling and ACM control.

In addition, the central station 100 allocates a type slot of an appropriate resource to a MF-TDMA return link through a forward/return link signaling procedure with the first to third terminal stations 300, 310, and 320 in order to perform mesh connection, and the first terminal station 300 transmits, at a corresponding type slot, a data burst having an appropriate MODCOD obtained by adding a mesh connection identifier allocated by the central station 100, allowing two mesh connections to the second and third terminals 310 and 320 to be established.

Here, as shown in FIG. 3, the data burst having the above-described MODCOD includes a burst header field and a burst payload field, and the burst header field includes a mesh connection identifier field and a mesh connection ACM information field. That is, an identifier for identifying a mesh connection and an ACM information field for performing ACM control of each mesh connection are included in front of a data payload field.

As shown in FIG. 3, the second or third terminal 310 or 320 receives a data burst if mesh connection identifier information recorded in a mesh connection identifier field of a burst header is the same as mesh connection identifier information allocated to the terminal among the data burst received through the time slot and deletes the received data burst if the recorded mesh connection identifier information is not the same as the allocated mesh connection identifier information.

In addition, through the above-described procedure, the first terminal station 300 may be accessed by the second or third terminal station 310 or 320 through unidirectional or bidirectional mesh connection.

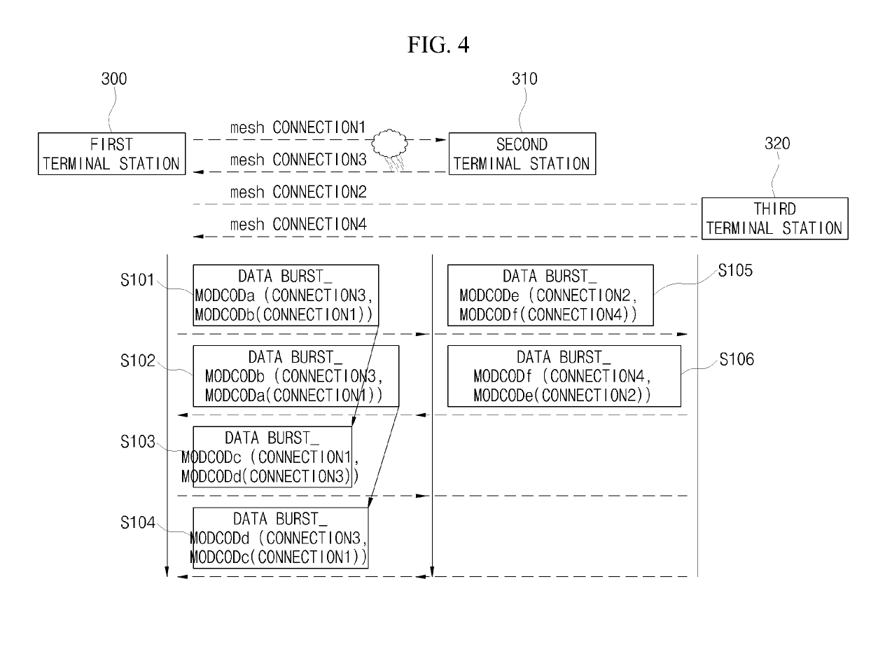

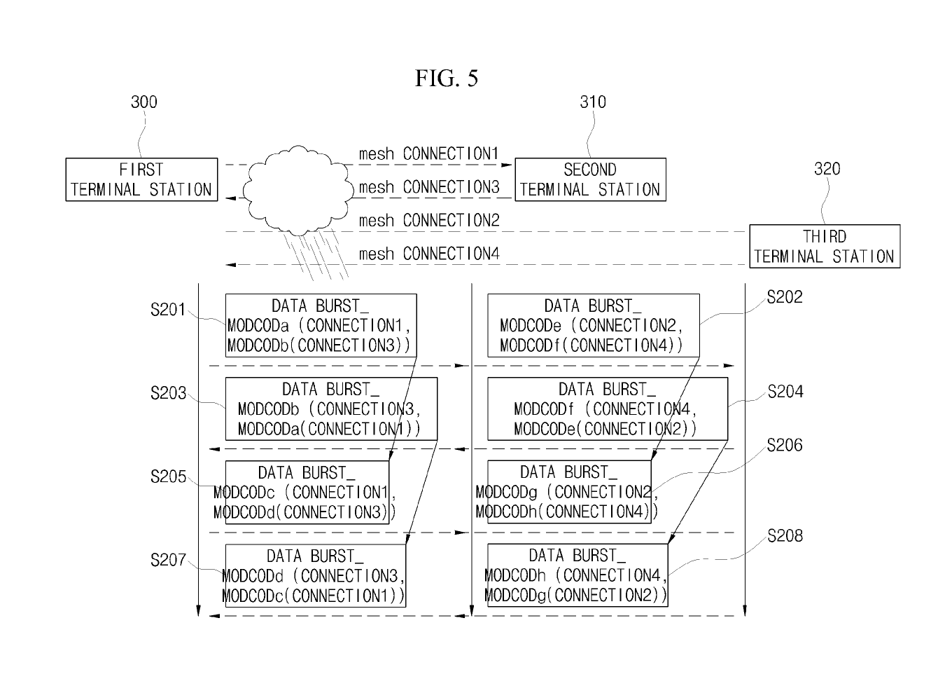

The first terminal station 300 monitors a state of each reception mesh connection, determines a corresponding MODCOD when there is link change, and then notifies the determined MODCOD to the second and third terminal stations 310 and 210, thus performing ACM control in units of mesh connections. The ACM control method may reduce a satellite delay and distribute signal processing to multiple terminal stations. Thus the ACM control method can rapidly cope with link change and have an advantage on large-scale mesh communication, compared to a related art method using a procedure of performing forward/return signaling via the central station 100. Hereinafter, a method of controlling ACM according to link change when the mesh communication is performed between different terminal stations 300, 310, and 320 will be described in detail with reference to FIGS. 4 and 5.

FIG. 4 is a view illustrating an example of an ACM control procedure in the satellite communication system according to the present invention. FIG. 4 illustrates an MODCOD control procedure when bidirectional mesh connection is established between the first terminal station 300 and the second and third terminals 310 and 320 and signal attenuation occurs on an uplink and downlink of the second terminal station 310.

First, as shown in FIG. 4, the first to third terminal stations 300, 310, and 320 perform forward/return signaling procedure via a central station 100 and a satellite. According to the signaling procedure, the central station 100 allocates all three type slots to the first to third terminal stations 300, 310, and 320, respectively. That is, in operation S101, the first terminal station 300 transmits, at the allocated type slot, a data burst to the second terminal 310 according to MODCODa through a mesh connection 1 link (mesh connection 1).

In operation S102, the second terminal station 310 transmits a data burst to the first terminal station 300 according to MODCODb through the mesh connection 3 link (mesh connection 3). In this case, the first and second terminal stations 300 and 310 monitor states of the mesh connection 1 link and the mesh connection 3 link, respectively, measure packet loss ratios or signal-to-noise ratios of the mesh connection 1 link and the mesh connection 3 link, compare the measured packet loss ratios or signal-to-noise ratios with a reference value for a packet loss ratio or signal-to-noise ratio, determine a required MODCOD according to the comparison result, and transmits the required MODCOD to another terminal 300 or 310.

Thus, in operation S103, the first terminal station 300 transmits a data burst to the second terminal station 310 using MODCOD information that is changed by request from the second terminal 310, that is, MODCODc. Here, it can be seen that the transmitted data burst includes identifier information about the second terminal station 310 and as shown in FIG. 4, in operation S103, the length of data in the data bust transmitted from the first terminal station 300 to the second terminal station 310 decreases according to the MODCODc.

In addition, in operation S104, the second terminal station 310 transmits a data burst to the first terminal station 300 using MODCOD information that is changed by request from the first terminal 300, that is, MODCODd. Here, it can be seen that the transmitted data burst includes identifier information about the first terminal station 300 and as shown in FIG. 4, in operation S104, the length of data in the data bust transmitted from the second terminal station 310 to the first terminal station 300 decreases according to the MODCODc.

In operations S105 and S106, it can be seen that in the mesh communication between the first terminal station 300 and the third terminal station 320, a data burst is transmitted and received according to MODCOD information initially determined by a time slot allocated through signaling with the central station 100.

To provide a summary on the above describe, when there is rain on mesh connection link between the first terminal station 300 and the second terminal station 310, the signal attenuation due to the rain makes the MODCOD be more robust and makes the size of data to be transmitted in a unit burst be small. That is, in a DVB-RCS2 specification to which the present invention is applied, the actual burst symbol length is fixed, and a PPDU data size to be transmitted according to the MODCOD is changed. In addition, bidirectional data burst transmission is achieved in bidirectional mesh connection between the first terminal station 300 and the third terminal station 320 according to the allocated MODCOD without change in the MODCOD.

FIG. 5 is a view illustrating another example of an ACM control procedure in the satellite communication system according to the present invention. FIG. 5 illustrates a MODCOD control procedure when signal attenuation occurs on an uplink and downlink of the first terminal station 300.

The first terminal station 300 monitors states of the mesh connections 3 and 4, the second terminal station 310 monitors a state of the mesh connection 1, and the third terminal station 320 monitors a state of the mesh connection 2. Each of the first to third terminal stations 300, 310, and 320 determines a MODCOD and notifies the MODCOD to a corresponding terminal station. Thus data burst transmission in the bidirectional mesh connection is achieved according to the MODCOD

That is, in FIG. 5, when there is no abnormality in links among the first, second, and third terminal stations 300, 310, and 320, each mutual mesh communication is performed according to MODCOD information that is initially allocated in operations S201 to S204. When there is rain falling on all mesh communication links, data burst transmission is achieved for bidirectional mesh connection according to the MODCOD in operations S205 to S208 by determining a MODCOD to notify the MODCOD to a corresponding terminal station.

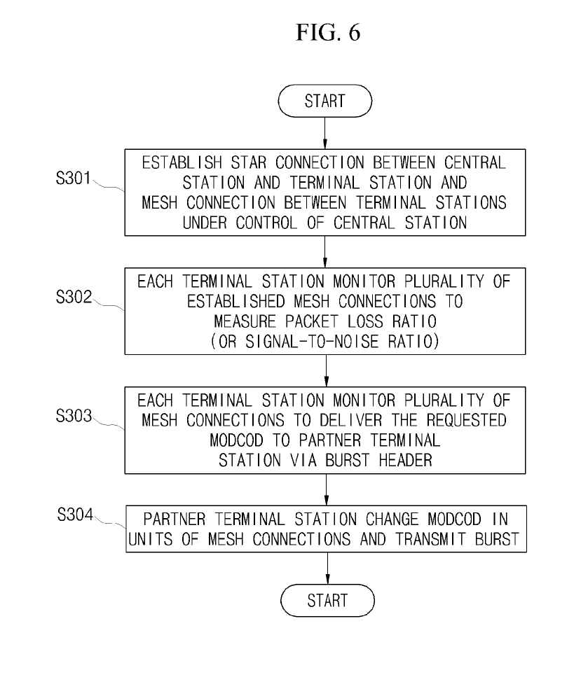

An ACM control method in a satellite communication system according to the present invention will be described stepwise with reference to FIG. 6.

FIG. 6 is a flowchart illustrating the ACM control method in the satellite communication system according to the present invention.

First, as shown in FIG. 6, a unidirectional or bidirectional mesh connection between terminal stations in a satellite communication network is established according to a DVB-RCS and C2P connection control protocol specification. That is, in operation S301, the central station establishes star and mesh connections between a central station and each terminal station under the control of the central station.

In operation S302, each terminal station measures packet loss ratios or signal-to-noise ratios for a plurality of mesh connections by monitoring a reception link.

In operation S303, each terminal station determines a MODCOD satisfying quasi-error-free on the basis of the measured packet loss ratio or signal-to-noise ratio, adds the MODCOD information to a burst header of a data burst as shown in FIG. 3, and delivers the data burst to another terminal station.

Responding thereto, the other terminal performs data burst transmission according to the received MODCOD. That is, in operation S304, the other terminal station changes the MODCOD in units of mesh connections, and then transmits the data burst according to the changed MODCOD. Accordingly, it is possible to perform ACM control according to MODCOD control for a number of mesh connections by performing monitoring in units of mesh connections and performing determination and notification of a requested MODCOD.

Although the invention has been described with reference to specific embodiments, it will be understood by those skilled in the art that various changes may be made without departing from the spirit or scope of the invention. Thus, the scope of the present invention shall not be restricted or limited by the foregoing detailed description, but is to be determined by the following claims and their equivalents.

What is claimed is:

1. A satellite mesh communication system comprising:
a central station configured to signal each terminal station through a star communication link, allocate a time slot for data burst transmission to each terminal station through the signaling, determine a MODCOD for mesh communication between terminals, and transmit the MODCOD according to the allocated time slot to each terminal station; and
a plurality of terminal stations configured to transmit/receive a data burst through a mesh connection with a corresponding terminal station through the MODCOD determined by the central station, check a state of a link connected with the partner terminal station, and transmit/receive a data burst to/from the corresponding terminal station according to the new determined MODCOD.

2. The satellite mesh communication system of claim 1, wherein the data burst transmitted/received between the terminal stations comprises a burst header field and a burst payload field.

3. The satellite mesh communication system of claim 2, wherein the burst header field comprises a mesh identifier field for identifying the terminal station intended to perform the mesh communication and a MODCOD information field for performing mesh connection ACM control determined depending on a link state.

4. The satellite mesh communication system of claim 1, wherein the checking of a state of a link connected with the corresponding terminal station comprises calculating a packet loss ratio of a received packet to check the link state.

5. The satellite mesh communication system of claim 1, wherein the checking of a state of a link connected with the corresponding terminal station comprises calculating a signal-to-noise ratio of a received packet to check the link state.

6. The satellite mesh communication system of claim 3, wherein each of the plurality of terminal stations checks a mesh connection identifier recorded in the data header of the received data burst, compares the recorded mesh connection identifier with a mesh connection identifier of the terminal station, receives a data burst when the mesh connection identifiers are the same, and deletes the received data burst when the mesh connection identifiers are not the same.

7. An ACM control method in a satellite mesh communication system including a central station and a plurality of terminal stations, the ACM control method comprising:
establishing, by the central station, star and mesh connections between the terminal stations;
receiving, by each terminal station, a data burst including MODCOD information for ACM control through the established mesh connection;
checking, by each terminal station, a mesh connection link state in response to reception of the data burst;
determining, by each terminal station, new requested MODCOD information in units of established mesh connections to transmit a data burst including the determined requested MODCOD information to a partner terminal station; and
changing a previous MODCOD according to the requested MODCOD to transmit a data burst in units of mesh connections according to the changed MODCOD.

8. The ACM control method of claim 7, wherein the data burst transmitted/received between the terminal stations comprises a burst header field and a burst payload field.

9. The ACM control method of claim 8, wherein the burst header field comprises a mesh identifier field for identifying the terminal station intended to perform the mesh communication and a MODCOD information field for performing mesh connection ACM control determined depending on a link state.

10. The ACM control method of claim 7, wherein the checking of a mesh connection link state comprises calculating a packet loss ratio of a received packet to check the link state.

11. The ACM control method of claim 7, wherein the checking of a mesh connection link state comprises calculating a signal-to-noise ratio of a received packet to check the link state.

12. The ACM control method of claim 9, wherein each of the plurality of terminal stations checks a mesh connection identifier recorded in the data header of the received data burst, compares the recorded mesh connection identifier with a mesh connection identifier of the terminal station, receives a data burst when the mesh connection identifiers are the same, and deletes the received data burst when the mesh connection identifiers are not the same.
